(19) United States
(12) Patent Application Publication
(10) Pub. No.: US 2012/0323599 A1
(43) Pub. Date: Dec. 20, 2012

(54) SCHEDULING OF DOSE CALCULATION TASKS INCLUDING EFFICIENT DOSE CALCULATION

(75) Inventors: Matthieu F. Bal, Cadier en Keer (NL); Robert T. Ward, Madison, WI (US); Scott L. Johnson, Madison, WI (US); Michael Kaus, Madison, WI (US)

(73) Assignee: KONINKLIJKE PHILIPS ELECTRONICS N.V., EINDHOVEN (NL)

(21) Appl. No.: 13/580,169

(22) PCT Filed: Feb. 8, 2011
(86) PCT No.: PCT/IB2011/005032

§ 371 Date: Aug. 21, 2012

Related U.S. Application Data
(60) Provisional application No. 61/311,407, filed on Mar. 8, 2010.

(51) Int. Cl. G06Q 50/22

(52) U.S. Cl. 705/2

(57) ABSTRACT

A system comprises a therapy tasks scheduling module (30) constructing a workflow schedule for performing a plurality of therapy tasks including dose optimizations, and a dose optimization module (26) performing a dose optimization in accordance with the workflow schedule to generate a therapy plan. The dose optimization module performs inverse radiation therapy planning that iteratively adjusts (82) a set of radiation therapy parameters (70) to optimize a simulated spatial dose distribution (72) respective to a set of radiation therapy objectives (78). In some embodiments, at least some iterations update a region of a fluence map that is smaller than the entire fluence map. In some embodiments, at least some iterations optimize the simulated spatial dose distribution respective to a subset of the set of radiation therapy objectives. In some embodiments, the simulated spatial dose distribution has a nonuniform voxel size.

The following relates to the oncology arts, medical therapy arts, inverse radiation therapy planning arts, dose optimization arts, and related arts.

A radiation therapy workflow typically entails initial planning imaging of the region to undergo radiation therapy. Computed tomography (CT) is a typical planning imaging modality, although other imaging modalities such as magnetic resonance (MR) can be used. Single photon emission computed tomography (SPECT) or positron emission tomography (PET) is sometimes used to provide functional information about the malignancy. An organ delination task is then performed using the planning images to delineate the target organ and any neighboring critical organs. A dose optimization calculation is performed using the planning image or images. The dose optimization calculation optimizes radiation therapy parameters such as settings of the multi-leaf collimator (MLC), intensity as a function of angle (for tomographic therapy session planning employing a rotating radiation source), or so forth. These parameters are optimized respective to objectives such as a desired radiation dose in the target organ (that is, the organ containing the malignancy), constraints on maximum radiation exposure of nearby critical organs or anatomical structures, or so forth. The dose optimization amounts to an “inverse” radiation therapy calculation in that the optimization starts with the desired dose and any dose constraints, as a function of position within the subject, and calculates the radiation therapy configuration that should, based on computer simulation, deliver that desired dose. The final output of the dose optimization is a radiation therapy plan specifying the radiation therapy configuration (defined by the optimized radiation therapy parameters) that according to the simulation will deliver a spatial dose profile satisfying the objectives.

Radiation therapy is sometimes performed using several successive radiation therapy sessions performed over a period of time, e.g. days or weeks. This approach has advantages including distributing the radiation dose delivery over time. In adaptive radiation therapy, the successive sessions (or some of the successive sessions) are updated based on imaging or other feedback acquired during the therapy.

The optimization is complex, for example involving optimizing thousands or tens of thousands of MLC parameters respective to a set of dose objectives (e.g., dose constraints or dose targets) for the target organ and other critical neighboring organs or structures. In adaptive radiation therapy, the radiation therapy plan may be adjusted by adaptation so as to avoid performing a complete dose optimization ab initio. For such adaptation, subsequently acquired images are registered with earlier-acquired images to assess changes such as organ movement, reduction in tumor size, or so forth. To increase computational power for performing these complex radiation therapy tasks, multiple computers, servers, digital processors, or so forth are optionally interconnected via a digital network as a computing grid to perform the optimization. Even so, some complex dose optimization planning sessions can take several hours of computing time.

Typically, one computer serves as the user interface to the computing grid and allows the user to adjust parameters, objective and optimization settings before or during the plan optimization. Via the user interfacing computer, the user identifies or selects as input the relevant information, such as: the planning images; organ contours, grids, or other delineation of the target organ and other critical structures in the planning images; the type of radiation therapy to be planned (typically specifying the target organ and the radiation therapy system configuration including identification of the adjustable parameters); and dose optimization objectives (typically the minimum dose or a dose range to be delivered to the target organ and maximum dose thresholds for neighboring critical organs which are not to be exceeded). The user interfacing computer and/or another computational tasks coordinating computer then organize the dose calculation and optimization computation session, including transfer of requisite data across the digital network, transfer of intermediate results between computers, and ultimately collection of the dose optimization information at the user interfacing computer. The dose optimization computation is performed iteratively, and at the end of each iteration a (simulated) dose is determined In some approaches, fluence maps for the beams are the adjustable parameters during the iterative optimization, and the directly controlled radiation therapy parameters (MLC settings, beam angles, or so forth) are computed by conversion of the final fluence maps output by the optimization into MLC settings or other controlled radiation therapy parameters. A disadvantage of this approach is that error can be introduced during the final step of converting the fluence maps into the controlled radiation therapy parameters. In an alternative direct machine parameter optimization (DMPO) approach, the controlled radiation therapy parameters (MLC settings, beam angles, or so forth) are the adjustable parameters that are adjusted during the iterative dose optimization, and accordingly the final conversion step is not needed. In either case, the iterative optimization continues until the simulated dose (or dose map, that is, the spatial dose distribution in the subject) satisfies all radiation therapy objectives, or until another stopping criterion is satisfied, such as incremental improvement from iteration-to-iteration being below a stopping threshold. When the dose optimization session is completed, the user reviews the results using the user interfacing computer and, if satisfactory, accepts and stores the radiation therapy plan for use in the radiation therapy session.

Existing radiation therapy planning is computationally intensive, and can constitute a bottleneck in the overall radiation therapy treatment workflow. Moreover, in some cases the final simulated dose for the optimized radiation therapy parameters may fail to satisfy one or more objectives. Depending upon the perceived importance of the missed objective or objectives and the extent to which the simulated dose deviates from the missed objective or objectives, the user may either elect to go ahead with the optimized radiation therapy plan (which could result in reduced radiation therapy effectiveness and/or radiation-induced damage to critical organs or anatomical structures) or may elect to repeat the radiation therapy planning session (which introduces further computational load on the radiation therapy planning system).

The following provides new and improved apparatuses and methods which overcome the above-referenced problems and others.

In accordance with one disclosed aspect, a system comprises: a therapy tasks scheduling module configured to construct a workflow schedule for performing a plurality of therapy tasks including dose optimizations; and a dose optimization module configured to perform a dose optimization in accordance with the workflow schedule to generate a therapy plan corresponding to the dose optimization; wherein the therapy tasks scheduling module and the dose optimization module comprise one or more digital processors.

In accordance with another disclosed aspect, a therapy dose optimization system is disclosed as set forth in the immediately preceding paragraph, wherein the dose optimization module is configured to perform inverse radiation therapy planning that iteratively adjusts a set of radiation therapy parameters to optimize a simulated spatial dose distribution respective to a set of radiation therapy objectives.

In accordance with another disclosed aspect, a storage medium stores instructions that when executed on one or more digital processors perform a method comprising performing a dose optimization to generate a therapy plan by inverse radiation therapy planning that iteratively adjusts a set of radiation therapy parameters to optimize a simulated spatial dose distribution respective to a set of radiation therapy objectives, wherein at least some iterations of the inverse radiation therapy planning update a region of a fluence map that is smaller than the entire fluence map.

In accordance with another disclosed aspect, a storage medium stores instructions that when executed on one or more digital processors perform a method comprising performing a dose optimization to generate a therapy plan by inverse radiation therapy planning that iteratively adjusts a set of radiation therapy parameters to optimize a simulated spatial dose distribution having a nonuniform voxel size respective to a set of radiation therapy objectives.

In accordance with another disclosed aspect, a storage medium stores instructions that when executed on one or more digital processors perform a method comprising performing a dose optimization to generate a therapy plan by inverse radiation therapy planning that iteratively adjusts a set of radiation therapy parameters to optimize a simulated spatial dose distribution respective to a set of radiation therapy objectives, wherein at least some iterations of the inverse radiation therapy planning optimize the simulated spatial dose distribution respective to a subset of the set of radiation therapy objectives.

In accordance with another disclosed aspect, a storage medium is disclosed as set forth in any one of three immediately preceding paragraphs, wherein the method further comprises: on a first one or more processors performing a first dose optimization to generate a first therapy plan by inverse radiation therapy planning; and concurrently on a second one or more processors performing a second dose optimization to generate a second therapy plan by inverse radiation therapy planning

One advantage resides in radiation therapy planning that more efficiently uses computational and digital data transfer resources.

Another advantage resides in increased likelihood of generating a radiation therapy plan that satisfies all, or at least the most important, radiation therapy objectives.

Further advantages will be apparent to those of ordinary skill in the art upon reading and understanding the following detailed description.

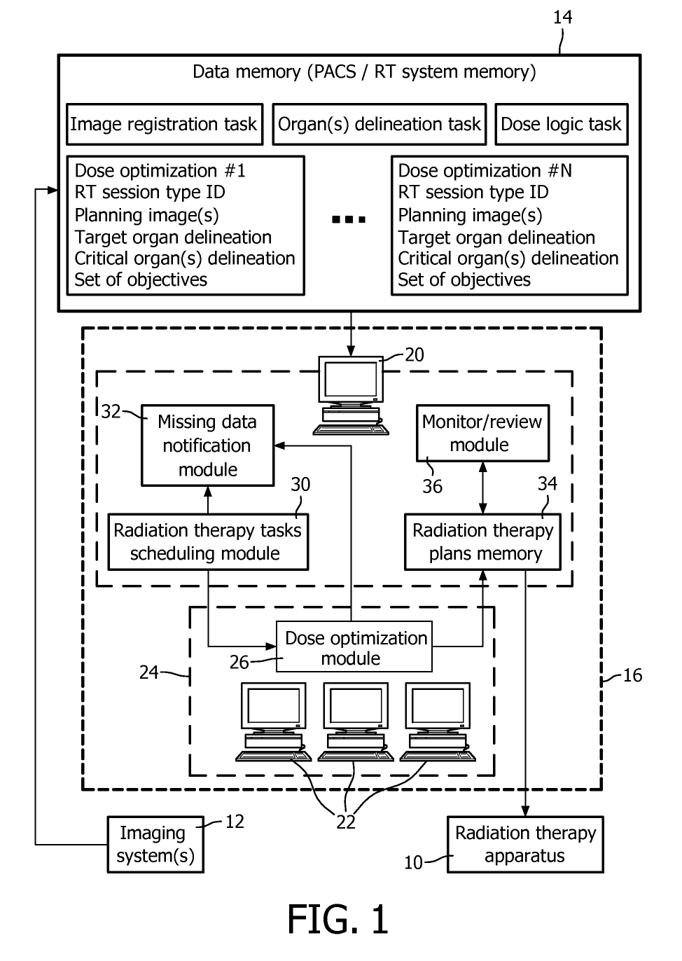

FIG. 1 diagrammatically illustrates a radiation therapy system.

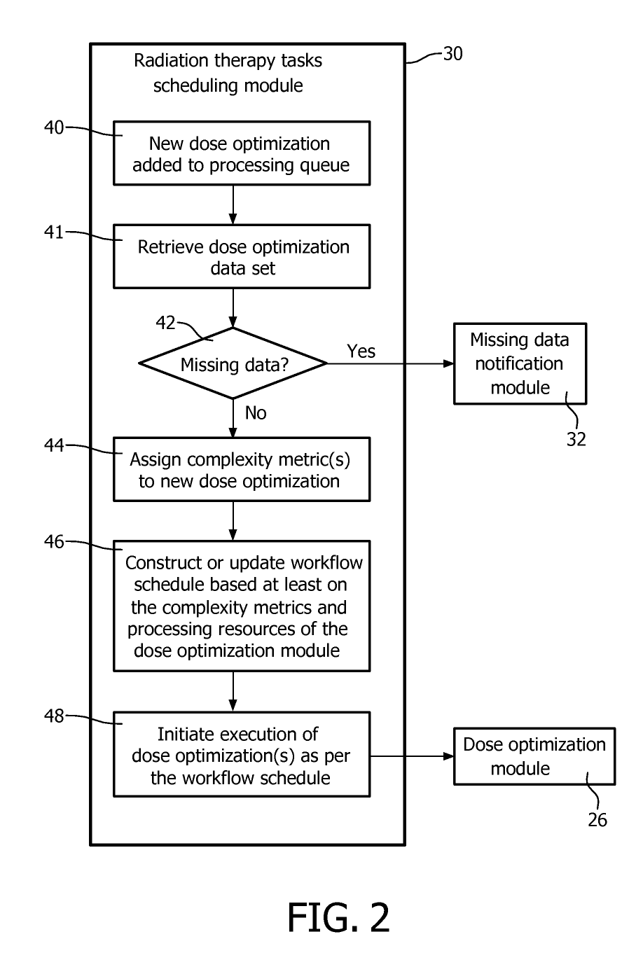

FIG. 2 diagrammatically illustrates the dose optimization schedule module of the radiation therapy system of FIG. 1.

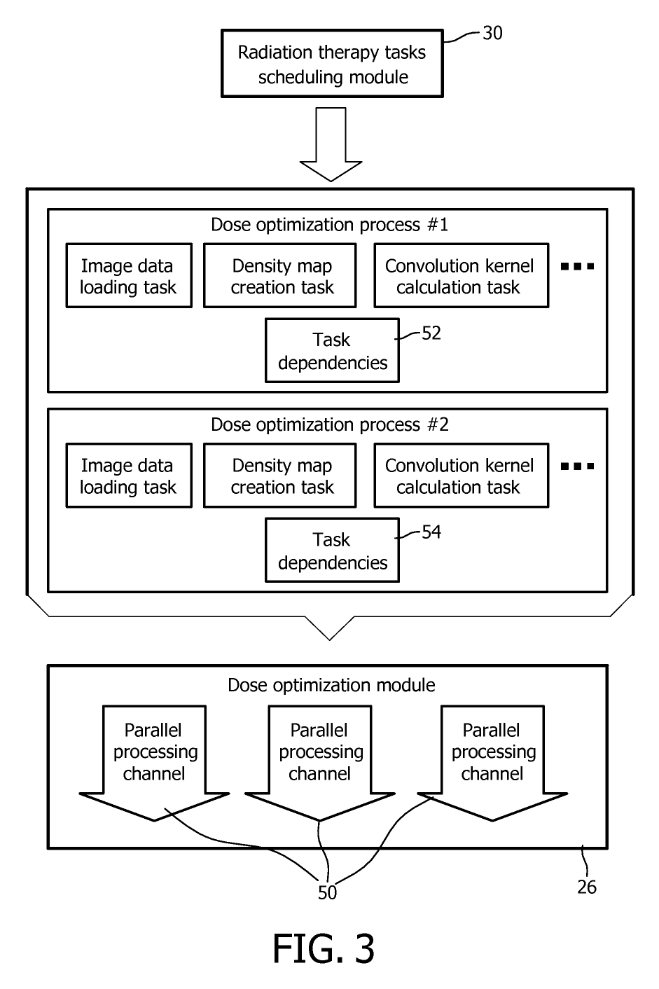

FIG. 3 diagrammatically illustrates cooperative operation of the dose optimization schedule module and the dose optimization module to perform concurrent processing of two dose optimization processes.

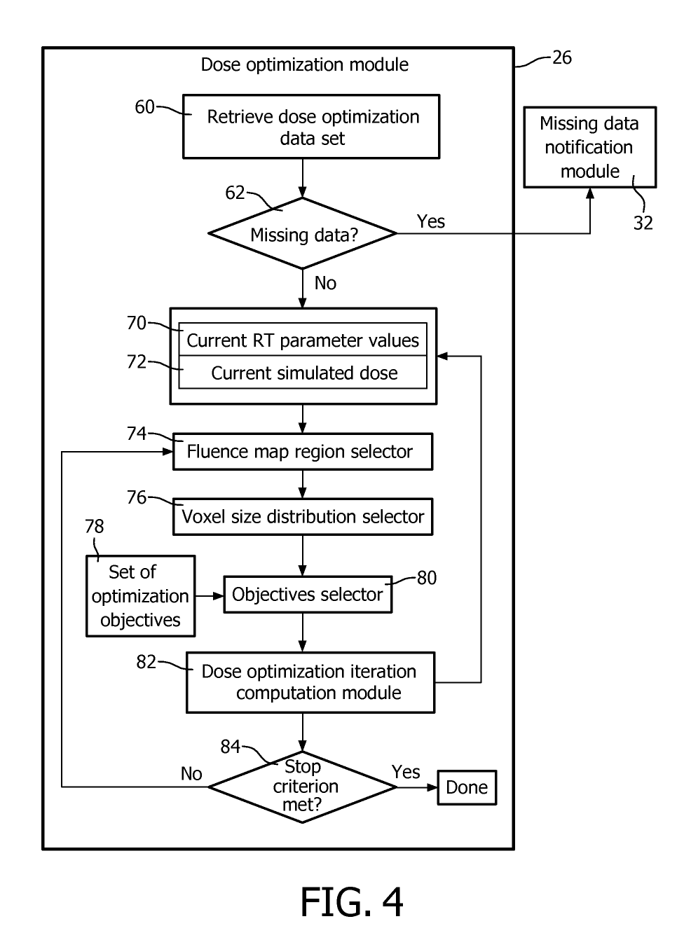

FIG. 4 diagrammatically illustrates the dose optimization module of the radiation therapy system of FIG. 1.

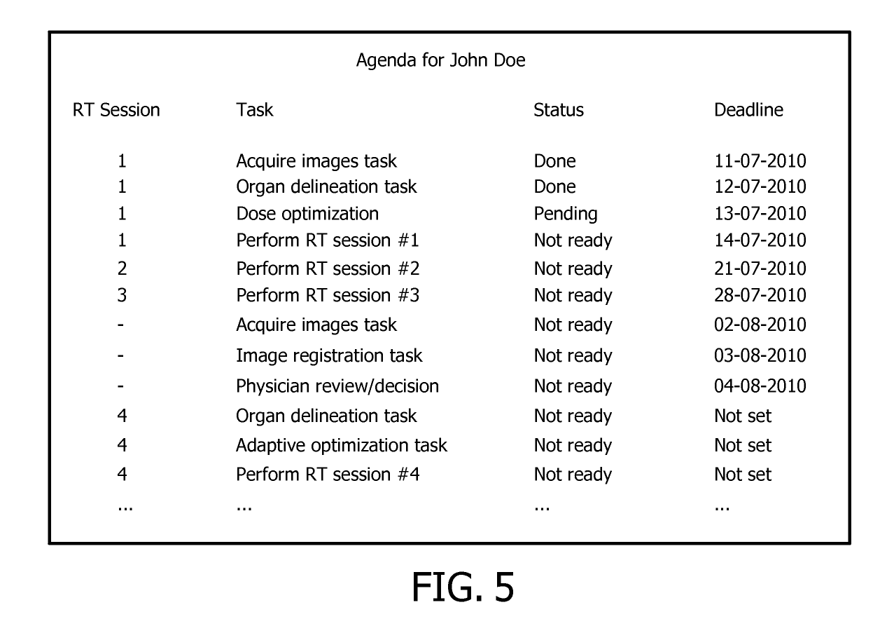

FIG. 5 diagrammatically illustrates a portion of a radiation therapy agenda for a patient “John Doe”.

With reference to FIG. 1, a radiation therapy system includes a radiation therapy apparatus 10, one or more imaging systems 12, a data memory 14, and a radiation therapy dose optimization system 16. A computer 20 provides a user interface for operating the radiation therapy dose optimization system 16.

The radiation therapy apparatus 10 is indicated diagrammatically in FIG. 1, and is suitably embodied by substantially any type of radiation therapy delivery system that delivers a spatially configurable therapeutic radiation dose. By way of example, the radiation therapy apparatus 10 may be a linear accelerator. The radiation therapy apparatus 10 may include a single beam source (optionally tomographically revolving around the radiation therapy subject), or multiple beam sources for simultaneously applying beams to the subject from different spatial angles or directions. The beam source or sources are configured to deliver therapeutic radiation beams of one or more selected types, such as a therapeutic electron beam, a therapeutic gamma ray beam, a therapeutic proton beam, or so forth. The radiation therapy apparatus 10 optionally includes one or more multi-leaf collimator (MLC) components for precisely shaping or spatially modulating the radiation beam, and/or the radiation beam can be revolved tomographically around the subject while modulating the beam intensity in order to achieve a selected time-integrated dose. The radiation therapy apparatus 10 may alternatively be embodied by another type of therapy delivery system that delivers targeted dosages of a therapeutic agent, such as a proton beam therapy system, a radiation ablation therapy system, high intensity focused ultrasound (HIFU) therapy, brachytherapy, chemotherapy, or so forth.

The one or more imaging systems 12 provide imaging data from which to assess interaction of the subject with the radiation beam. In general, the subject anatomy is determined by images acquired by the imaging system or systems 12, and based on this anatomical information the expected radiation absorption in various tissues can be calculated. Optionally, the images acquired by the imaging system or systems 12 may also be used to assess the radiation absorption characteristics of the various tissues (for example, characterized by absorption coefficients). The one or more imaging systems 12 may include, for example: a computed tomography (CT) imaging system; a magnetic resonance (MR) imaging system; one or more radioemission imaging systems such as positron emission tomography (PET) or single photon emission computed tomography (SPECT) imaging systems; or so forth. CT is a commonly used imaging modality for radiation therapy planning, because CT provides substantial anatomical information. Additionally, in some approaches the CT images are used to derive radiation absorption characteristics of the tissues. PET and/or SPECT are optionally used to provide functional information such as standardized uptake value (SUV) information.

The data memory 14 stores information required for performing the dose optimization or other radiation therapy-related tasks such as rigid or nonrigid image registration, automatic, semiautomatic, or manual organ delineation, dose logic (e.g., dose accumulation or subtraction), or so forth. By way of example, for dose optimization this information may include: the planning images acquired by the one or more imaging systems 12; an identification of the radiation therapy session type (which determines the radiation therapy parameters to be optimized, such as settings of the MLC if the radiation therapy system 10 includes a MLC, intensity as a function of angle if the radiation therapy system 10 is tomographic, or so forth); target organ delineation; delineation of critical organs or structures; and a set of radiation therapy objectives, such as the minimum dose (or a dose range) to be delivered to the target organ, a maximum dose not to be exceeded in a critical organ, or so forth. For an organ delineation task the requisite information may include one or more images and (in the case of automatic or semiautomatic organ delineation) a deformable anatomical model or other supplementary information for use in automatic or semi-automatic image segmentation. In an organ delineation task, delineations of the target organ and critical organ or organs (if any) are generated from the planning images acquired by the one or more imaging systems 12. These delineations may be generated manually, for example via a computer that provides a graphical user interface for displaying a planning image and enabling the user to manually delineate contours around the target and critical organs. These delineations may additionally or alternatively be generated automatically, for example using an automated image segmentation algorithm. The delineation task operations may be performed by a computer of the one or more imaging systems 12, or by the user interface computer 20 of the radiation therapy dose optimization system 16, or by another computer or digital device, such as a radiologist's personal computer (not illustrated). The data memory 14 may be embodied as one or more logical or physical memory elements, such as a picture archiving and communication system (PACS) memory storing the planning images, and/or a system memory of the radiation therapy planning system 16, and/or so forth. In an image registration task, for example performed as part of an adaptive radiation therapy session in which the radiation therapy plan is adapted to changed conditions (rather than performing a dose optimization ab initio), the requisite information includes one or more earlier images representing an earlier state of the patient, and one or more current images representing the current state of the patient. An image registration task can be performed for other purposes, for example in order to fuse images acquired by different modalities such as CT and PET. A dose logic task performs an analysis such as computing dose accumulation, and the requisite information includes quantitative information about the relevant radiation dose, for example delivered to the patient over each of several sessions.

A dose optimization or other radiation therapy-related task cannot be performed until the requisite data are available in the data memory 14. For example, a dose optimization cannot be performed until: (i) the requisite planning images are acquired and stored in the data memory 14; (ii) the organ delineations are generated from those planning images and stored in the data memory 14; and (iii) the radiation therapy session type identified along with input of the set of radiation therapy objectives. As a consequence, one or more dose optimizations awaiting execution may be stored in the data memory 14, some of which may be awaiting receipt and storage of requisite data, some of which may be complete data sets ready for the dose optimization to be executed. Without loss of generality, FIG. 1 diagrammatically indicates N dose optimizations awaiting execution that are stored in the data memory 14, where N is an integer greater than or equal to unity, and in some embodiments is an integer greater than or equal to two. By way of further example, FIG. 1 also diagrammatically shows a pending image registration task, a pending organ delineation task, and a pending dose logic task.

The illustrated radiation therapy dose optimization system 16 is embodied by a plurality of computers, including the user interface computer 20 that provides a user interface for operating the radiation therapy dose optimization system 16, and a plurality of computers 22 that perform a dose optimization to generate a radiation therapy plan corresponding to the dose optimization. The plurality of computers 22 are interconnected via a digital network to form a computing grid 24 for performing the dose optimization. The computing grid 24 of interconnected computers 22 collectively operate to embody a dose optimization module 26 that performs the dose optimization. Although not illustrated, the computing grid 24 may also provide modules for performing other radiation therapy-related tasks such as image registration or organ delineation. In the illustrated embodiment the user interface computer 20 is not part of the computing grid 24; however, optionally the user interface computer 20 may also be included in the computing grid.

The user interface computer 20 provides a user interface (optionally graphical, that is, a graphical user interface or GUI) by which a radiologist or other human user interacts with the radiation therapy dose optimization system 16. Additionally, in the illustrated embodiment the user interface computer 20 embodies a radiation therapy tasks scheduling module 30 that is configured to construct a workflow schedule for performing a plurality of dose optimizations, image registration tasks, organ delineation tasks, or other radiation therapy tasks, such as the N dose optimizations whose data are stored in the data memory 14 in the illustrated embodiment. Optionally, the radiation therapy tasks scheduling module 30 checks the data for each task for completeness, and if missing data are detected that prevent execution of the task, a missing data notification module 32 is invoked to inform the user of the missing data.

The dose optimization module 26 performs the plurality of dose optimizations in accordance with the workflow schedule generated by the radiation therapy tasks scheduling module 30 to generate a plurality of radiation therapy plans corresponding to the plurality of dose optimizations. Optionally, the dose optimization module 26 also checks the data for each dose optimization for completeness, and invokes the missing data notification module 32 to inform the user of any missing data. This second check is optional, but if employed can advantageously detect data that may have been deleted, corrupted, or otherwise compromised some time after the time the dose optimization was scheduled.

The generated radiation therapy plans are stored in a radiation therapy plans memory 34, which in the illustrated embodiment is a data storage component of the user interface computer 20 but which may in general be embodied by any available memory such as the data memory 14, or a memory associated with the radiation therapy apparatus 10, or so forth. A monitor/review module 36 enables the radiologist or other human user to review the radiation therapy plan including the spatial dose distribution simulated for the radiation therapy plan to verify, approve, or otherwise assess the radiation therapy plan. Ultimately, the radiation therapy apparatus 10 executes radiation therapy plan to provide radiation therapy to the subject.

The radiation therapy system has been described with reference to FIG. 1. With continuing reference to FIG. 1 and with reference to further drawings, additional aspects of the radiation therapy system are described.

With reference to FIG. 2, an illustrative embodiment of the radiation therapy tasks scheduling module 30 schedules tasks such that the workload is well spread, and anticipates and prepares for upcoming dose calculations. The different types of dose optimizations or other radiation therapy-related tasks differ in computational complexity or load, and also differ in the amount of involved user interaction. By estimating the computation time of a set of optimization plans or other tasks to be executed, the plans can be arranged and scheduled such that the workload is well spread over a longer period of time. By using the scheduling and/or triggered by a user opening a dose optimization, the scheduling module 30 can anticipate and schedule next steps such as loading the data can be loaded from the data memory 14 and performing certain calculations such as creation of the high-resolution density map and kernel calculation. During the dose optimization, the data related to dose computation can be kept in random access memory (RAM) or another fast-retrieval memory. Alternatively, data can be stored in the data storage 14 and restored back to RAM or other fast-retrieval memory by taking into account when the next dose calculation of that beam is expected. With the help of protocols, the scheduling module 30 can schedule automatic tasks, adjust the workload of the dose optimization module 26 by prioritizing time-critical calculations and scheduling follow-up steps demanding user interactions according to a determined (optimal) workflow schedule.

In the embodiment of FIG. 2, in an operation 40 a new dose optimization is added to the processing queue, and in an operation 41 the dose optimization data set is retrieved. Typically, the operation 40 corresponds to a completion of the data set (including by way of example planning images, organ delineations, session type identification, and selection of the set of radiation therapy objectives), although in some embodiments a dose optimization may be scheduled before all relevant data are collected under the assumption all data will be available by the time the dose optimization is scheduled to be executed. At an optional check operation 42, it is determined whether any requisite data are missing—if so, the missing data notification module 32 is invoked to inform the user of the missing data.

In an operation 44, a complexity metric is assigned to the new dose optimization. In some embodiments, a single complexity metric is assigned to the dose optimization. In other embodiments, a plurality of complexity metrics are assigned, for example for different tasks that make up the dose optimization. The complexity metric or metrics can be based on various factors that correlate with computational complexity, such as: radiation therapy session type (for example, dose optimization of a radiation therapy session delivering a radiation dose to an abdominal organ may be expected to be less computationally intensive than dose optimization for a radiation dose to be delivered to the neck, because the neck radiation therapy generally demands a more complex dose distribution and therefore more parameters for the optimization, such as more beams and/or more segments per beam); number of radiation therapy parameters (more parameters generally correlates with higher computational complexity); spatial resolution (higher spatial resolution generally correlates with higher computational intensity); requisite precision (a more precise dose optimization is likely to take more iterations and hence more computational time); and so forth. If multiple complexity metrics are assigned for different tasks of the dose optimization, then each complexity metric suitably depends upon relevant factors. For example, a higher number of radiation therapy parameters may have little or no effect on the per-iteration fluence map update task but may have a large effect on the per-iteration parameters update task. The complexity metric or metrics provide a quantitative assessment of the workload imposed by the measured dose optimization or dose optimization task.

In an operation 46, the workflow schedule is constructed or updated based at least on the complexity metrics and the available processing resources of the dose optimization module 26. The processing resources may, for example, include the number of parallel processing channels, if any, provided by the dose optimization module 26. (See FIG. 3 for further disclosure relating to this aspect). Another aspect of the processing resources may be the availability of any application-specific integrated circuitry (ASIC). For example, an ASIC dedicated a single dose optimization task reduces the computational load of that task.

In addition to the complexity metrics and available processing resources, the workflow scheduling operation 46 may take into account other information in generating the workflow schedule. For example, the dose optimization scheduling module 30 can be configured to construct the workflow schedule such that operations that do not require user input are performed during off-hour time intervals. Tasks which do require user input are preferably scheduled to be performed during normal working hours, or alternatively may be queued to be performed when a radiologist or other human user logs into the user interface computer 20. In this regard, the dose optimization scheduling module is optionally configured to construct the workflow schedule such that different user input operations are not scheduled concurrently.

As another example, the workflow scheduling operation 46 can construct the workflow schedule including a scheduled imaging data pre-load operation and one or more scheduled data processing operations timed in the workflow schedule such that imaging data processed by the one or more scheduled data processing operations is preloaded into a memory by the scheduled imaging data pre-load operation.

As another example, the workflow scheduling operation 46 can construct the workflow schedule to: (i) group together a plurality of data processing operations operating on a common data set; and (ii) keep the common data set in memory during execution of the plurality of data processing operations operating on the common data set. The common data set may include processed data, data such as look-up tables that are utilized by computations, or so forth. Optionally, in such cases the workflow scheduling operation 46 is further configured to schedule a data loading operation that loads the common data set into memory prior to execution of the plurality of data processing operations operating on the common data set.

With continuing reference to FIG. 2, once the workflow schedule is generated, an operation 48 communicates with the dose optimization module 26 to initiate execution of a dose optimization (or optionally two or more dose optimizations if the dose optimization module 26 provides parallel processing channels as illustrated in FIG. 3). Optionally, during execution of dose optimization(s) the operation 40 is performed if a new dose optimization is received in the queue.

Optionally, during execution of dose optimization(s) the operations 44, 46 are performed if execution to date has deviated or is deviating significantly from the computation workload or computation time assumed by the workflow schedule construction operation 46. For example, if a currently executing dose optimization task is actually more computationally intensive than was expected, then the workflow schedule construction operation 46 may be invoked to adjust the workflow schedule to perform a less computationally intensive operation in parallel or subsequently.

With reference back to FIG. 1 and with further reference to FIG. 3, in some embodiments the dose optimization module 26 provides a plurality of parallel processing channels, such as an illustrated three parallel processing channels 50 illustrated in FIG. 3. The parallel processing channels 50 may, for example, correspond to the different computers 22 of the computing grid 24. If one or more of the computers 22 has a multi-core processor, then the parallel processing channels 50 may correspond to different processing cores of the multi-core processor. If one or more of the computers 22 includes or has operative access to ASIC dedicated to a certain dose optimization task, then the ASIC optionally defines one of the parallel processing channels 50. Optionally, one or more of the computers 22 may include a graphical processing unit (GPU) which provides a parallel processing channel of higher computational speed. Still further, one or more of the parallel processing channels 50 may be defined virtually, for example by software-implemented multitasking performed by a single one of the computers 22.

As diagrammatically indicated in FIG. 3, in embodiments in which the dose optimization module 26 provides a plurality of parallel processing channels 50, two or more dose optimizations (e.g., dose optimization #1 and dose optimization #2 in illustrative FIG. 3) are optionally performed concurrently. Additionally or alternatively, the plural parallel processing channels 50 can be used to concurrently perform different tasks of a single dose optimization. For example, each of illustrative dose optimization #1 and dose optimization #2 include an image data loading task, a density map creation task, a convolution kernel calculation task, and so forth. Various of these tasks can be performed concurrently. However, if one task requires as input the output of another task, then those two tasks cannot be performed concurrently. Toward this end, dose optimization #1 includes task dependencies data 52, and similarly dose optimization #2 includes task dependencies data 54. Thus, for example, if task dependencies data 52 indicate that a task “B” is dependent on a task “A”, then tasks “A” and “B” cannot be executed concurrently, and indeed task “A” must be executed before task “B”. In a variant dependency, if task “B” employs a first-in-first-out (FIFO) usage of an output datastream of task “A”, then tasks “A” and “B” may optionally be executed concurrently so long as task “A” starts first and task “B” is delayed until task “A” has generated enough of its datastream for task “B” to usefully process.

In general, the workflow scheduling operation 46 constructs the workflow schedule to reduce variation in computational load over a selected time horizon. For example, the workflow scheduling operation 46 may schedule the N dose optimizations over a time horizon of 24 hours (or 36 hours, or 48 hours, or so forth). Where plural parallel processing channels 50 are provided by the dose optimization module 26, the workflow scheduling operation 46 preferably constructs the workflow scheduling operation 46 to balance the workload amongst the plural parallel processing channels 50. This can be done by optimizing the workflow schedule such that the complexity metrics of the tasks being performed by the different processing channels 50 (optionally averaged over a selected time unit of processing) are similar or the same.

However, if two of the parallel processing channels 50 employ the same processing hardware (for example, both processing channels virtually implemented on the same computer using software-implemented multitasking) then the workload of those two processing channels together is preferably treated as a unit for the purpose of balancing the work load, for example, by summing the complexity metrics of the tasks assigned to those two channels (or integrating the complexity metrics over the time unit of processing).

With reference to FIG. 4, an illustrative embodiment of the dose optimization module 26 is described. The illustrative dose optimization module 26 includes aspects for enhancing efficiency, including techniques to minimize data transfer during the dose optimization, techniques to minimize repetitive calculations with unchanged data during dose optimization, techniques to adapt dimensions and provide non-constant voxelsizes of the dose volume, and techniques to adapt the set of objectives in the optimization. In an operation 60 the dose optimization data set is retrieved, and in an optional check operation 62 the retrieved data set is checked for missing data and if data are identified as missing then the missing data notification module 32 is invoked. As already described, in some embodiments the operations 60, 62 may be performed as a data pre-loading task scheduled by the scheduling module 30 to be performed ahead of time.

The illustrative dose optimization is an inverse radiation therapy planning that iteratively adjusts a set of radiation therapy parameters to optimize the dose (or, more precisely, the spatial dose distribution in the subject) respective to a set of radiation therapy objectives. Various initialization process operations (not illustrated in FIG. 4) are suitably performed before the first iteration, such as: constructing a density map of the subject (unless this is already provided in the data memory 14); selection of initial values for the radiation therapy parameters (this can be done by accepting user inputted initial parameter values, using “typical” parameter values, or so forth); computing the convolution kernel; computing an initial (simulated) spatial dose distribution based on the subject density map and the initial radiation therapy parameters, and so forth. The output of these initial operations is a current set of radiation therapy parameter values 70 and a current simulated spatial dose distribution 72. The values of the current set of radiation therapy parameter values 70 are to be iteratively optimized until the current fluence map 72 satisfies the set of radiation therapy objectives. In some embodiments, the radiation therapy parameter values 70 are the fluence maps of the beams, which are then converted to directly controlled radiation therapy parameters such as MLC settings after the optimization is complete. In other embodiments, a direct machine parameter optimization (DMPO) approach is employed, in which the radiation therapy parameter values 70 are the directly controlled radiation therapy parameters such as MLC settings.

To initiate an iteration, an optional fluence map region selector 74 selects a region of the fluence map that is smaller than the entire fluence map 72 for updating by an iteration of the iterative inverse radiation therapy planning. Inclusion of the region selector 74 is based on the observation made herein that, over successive iterations of the optimization of a plan, the differences in MLC positions are typically small. By employing the region selector 74 which uses the previous fluence map iteration as reference, only a region of that fluence map is selected to be propagated through the density volume again in the new iteration to calculate the terma. The resulting difference in terma can be used for a difference in dose calculation using a convolution. In embodiments in which a plurality of processors are interconnected by a digital network, efficiency is enhanced by transferring only the selected region of the fluence map over the digital network during the iteration.

Another approach for enhancing efficiency is to configure the dose optimization module 26 to define the spatial dose distribution 72 for processing with a nonuniform voxel size across the volume. Toward this end, a voxel size distribution selector 76 adjusts voxel sizes of voxels of the dose distribution 72 between iterations of the inverse radiation therapy planning Said another way, instead of using a dose grid with constant dimensions and voxel sizes, the voxel size distribution selector 76 defines a set of dose voxels with variable voxel sizes prior to each iteration (or, in a variant embodiment, prior to a set of iterations). The location and size of the voxels suitably depends on the optimization and the radiation therapy objectives. For example, in some embodiments a large voxel size is used for the start of optimization and the voxel size is reduced when the final solution is approached. This gradual reduction in voxel size from iteration to iteration can be spatially nonuniform, with a faster reduction in size in spatial regions where the change from one iteration to the next is small (indicating the optimization is close to convergence in that area). The voxel size distribution selector 76 can also adjust the voxel size to use smaller voxels in regions where precision in the spatial distribution of the dose is critical, for example, in a region where the target organ and a critical organ are in close proximity On the other hand, larger voxels can be used in regions where precision in the spatial distribution of the dose is less critical, such as in regions far away from both the target organ and any critical organs.

With continuing reference to FIG. 4, the inverse radiation therapy planning iteratively adjusts the radiation therapy parameters 70 to optimize the dose 72 respective to a set of radiation therapy objectives 78. In some embodiments, an objectives selector 80 selects a subset of the set of radiation therapy objectives, and at least some iterations of the inverse radiation therapy planning optimize the dose 72 respective to the selected subset of the set of radiation therapy objectives. This aspect is motivated by the recognition herein that each objective increases the complexity of the solution space of the inverse problem to solve during the dose optimization. By letting the system gradually increase the number of objectives by operation of the objectives selector 80, the optimization can be made more robust.

For example, a first one or more iterations of the inverse radiation therapy planning are suitably performed respective to a first subset of the set of radiation therapy objectives, and subsequently a second one or more iterations of the inverse radiation therapy planning are performed respective to a second subset of the set of radiation therapy objectives different from the first subset. The second subset of the set of radiation therapy objectives suitably includes all radiation therapy objectives contained in the first subset of the set of radiation therapy objectives and further includes at least one additional radiation therapy objective of the set of radiation therapy objectives that is not contained in the first subset of the set of radiation therapy objectives. By extending this process, more additional radiation therapy objectives can be incorporated in the optimization of the dose 72 until the entire set 78 of radiation therapy objectives are incorporated.

In a variant approach, the set of radiation therapy objectives includes (without loss of generality) N radiation therapy objectives where N is greater than or equal to two. Further, in this embodiment the radiation therapy objectives of the set of radiation therapy objectives 78 are ranked by priority. For example, it may be a highest priority that the dosage delivered to a particularly vital organ be kept below a certain threshold objective. A lower priority may be that the dosage delivered to a less vital (albeit still critical) organ be kept below a certain threshold. A still lower priority may be that the dosage to this less vital organ be kept below another (lower) dose threshold. The subset of the set of radiation therapy objectives selected by the objective selector 80 includes N_{sub} radiation therapy objectives having highest priority ranking in the set of radiation therapy objectives 78, where 1≦N_{sub}<N. In effect, this ensures that the first iterations of the optimization adjust the radiation therapy parameters so that the dose 72 meets the N_{sub} highest-priority radiation therapy objectives. Once these highest priority objectives are met, the value of N_{sub} can be increased to include additional, lower priority objectives, until ultimately N_{sub} is increased to equal N and the final iterations adjust the dose 72 to satisfy the entire set of radiation therapy objectives 78. An advantage of this approach is that it increases the likelihood of generating a radiation therapy plan that satisfies at least the most important radiation therapy objectives, as ranked by the priority rankings

In some embodiments, the objectives are added in successive iterations by the objectives selector 80 in such an order that the path of radiation therapy plans evaluated during the dose optimization contain useful information. For instance the objectives selector 80 may be configured to perform the first few iterations with only tumor control probability (TCP) objectives selected. Once a reasonable convergence is reached, the objectives selector 80 adds in normal tissue complication probability (NTCP) objectives. In this case, the user can later on scroll and (re)evaluate the tradeoff made between tumor control and normal tissue complication probabilities. In parallel, an optimization could have started that is biased toward the NTCP objectives with the TCP objective assigned low weight, and later on have added TCP objectives (by increasing its weight) to estimate the spreading/variation possible with different NTCP-TCP proportions.

With continuing reference to FIG. 4, once the optional fluence map region selector 74 selects the fluence region to be adjusted by the iteration, and the voxel size distribution selector 76 adjusts the spatial distribution of voxel sizes for the iteration, and the objectives selector 80 chooses the (sub)set of objectives for the iterations, a dose optimization iteration computation module 82 performs an iteration that includes computing adjusted radiation therapy parameters (e.g., adjusted fluence maps for the beams, or adjusted MLC settings in the case of DMPO) and an updated simulated spatial dose distribution simulated to be generated by the adjusted radiation therapy parameters. These then become the current radiation therapy parameters 70 and current dose 72, respectively. In a decision operation 84 the iterative processing is checked against one or more stop criterion. If no stop criterion is met, then processing returns to the operation 74 for execution of the next iteration. Once a stop criterion is met as determined by the decision operation 84, iterating stops. In embodiments in which the fluence maps of the beams serve as the radiation therapy parameters 70 during iterative optimization, a final conversion step (not shown in FIG. 4) converts the fluence maps to MLC settings or other directly controlled radiation therapy parameters. This conversion operation is not needed in the case of DMPO.

Returning to FIG. 1, the optimized radiation therapy plan is stored in the memory 34, and can be reviewed by the radiologist or other user via the monitor/review module 36, and ultimately the optimized radiation therapy plan can be executed by the radiation therapy apparatus 10 in order to deliver therapeutic radiation to the subject.

With continuing reference to FIG. 1 and with further reference to FIG. 5, the radiation therapy tasks scheduling module 30 can similarly schedule other radiation therapy-related tasks besides dose optimizations. As shown in FIG. 5, a radiation therapy facility typically maintains a patient agenda, such as an illustrative agenda for “John Doe” shown (in part) in FIG. 5. The agenda for John Doe corresponds to a multi-session adaptive radiation therapy treatment, and includes a list of tasks to be performed together with the status of each task and a deadline for each task. In multi-session radiation therapy the schedule of radiation treatment sessions and auxiliary operations such as imaging is strict, and the indicated deadlines must be met. On the other hand, a task cannot be performed until the requisite information is acquired and available, for example in the data memory 14 of FIG. 1, and moreover in some instances a later task cannot be performed until an earlier task is completed. (As a trivial example, radiation therapy session #3 cannot be performed until after radiation therapy session #2 is completed). Thus, each task in the illustrative agenda has a status of “Done” indicating the task has been completed, or “Pending” indicating that the task is ready to be performed (that is, the requisite information is acquired) but has not yet been performed, or “Not ready” indicating that some requisite information is needed or some earlier task must first be performed. In the illustrative “time snapshot” of FIG. 5, the date is around Jul. 12, 2010 or Jul. 13, 2010, and the patient is soon to undergo a first radiation therapy session having a deadline of Jul. 14, 2010. Toward this end, the tasks of acquiring planning images and performing organ delineation have been performed (status=“Done”), and the dose optimization task is pending with a deadline of Jul. 13, 2010.

An additional two radiation therapy sessions (#2 and #3) are also scheduled. These sessions will use the same dose optimization as that used in session #1. Thereafter, new patient images are acquired by CT or another suitable imaging technique and are registered with the images acquired prior to session #1. A physician review/decision task is then scheduled, at which time John Doe's physician will assess progress of the treatment. It is anticipated that the physician's decision will be to go forward, at which time organ delineation would be performed using the new patient images, followed by an adaptive optimization task that adjusts the dose optimization to account for any changes (e.g., tumor shrinkage, organ movement, or so forth). These events after the physician review/decision do not yet have set deadlines, since the physician review may result in changes in the subsequent agenda for patient John Doe. However, it is also contemplated that, although the status is “Not ready” and has no decision deadline, the decision can be assigned a time slot such that subsequent open tasks (with perhaps a probability of occurrence assigned to them) can be used by the radiation therapy tasks scheduling module 30 to generate an estimate of the future workload for use in the scheduling of radiation therapy-related tasks.

With continuing reference to FIGS. 1 and 5 and with further reference to FIG. 2, as each task in the agenda transitions from the status “Not ready” to the status “Pending”, the task is added to the processing queue in an operation corresponding to the operation 40 illustrated in FIG. 2. The queued task is also tagged with its associated deadline. The radiation therapy tasks scheduling module 30 then updates the workflow schedule to include the newly added task as per the process described herein with reference to FIG. 2. The process of FIG. 2 is directed to scheduling a dose optimization task by way of illustrative example; however, analogous processing is performed for other types of tasks such as an image registration task or an organ delineation task. The requisite information is retrieved and optionally checked as per operations 41, 42, the complexity of the newly queued task is quantitatively assessed as per operation 44, the workflow schedule is updated as per operation 46 to include the newly queued task, and the pending task is performed in accordance with the updated workflow schedule as per operation 48.

The complexity metric employed in the operation 44 is suitably task-specific. Example are set forth herein for a dose optimization task; by way of another illustrative example, for an image registration task the complexity metric may be based on the sizes of the images to be registered, the type of registration (e.g., rigid or nonrigid image registration), a specified spatial precision, or so forth.

In performing the schedule update operation 46, the task deadline is treated as a hard constraint, i.e. the newly queued task must be completed by its assigned deadline. The update operation 46 may optionally also include other constraints. For example, if there is only one user interface available for performing manual or semi-automated organ delineation, then the update should be constrained such that only one such organ delineation task be scheduled at any given time.

Once scheduled, the pending task is performed as per operation 48, by invoking a suitable task module. For example, a dose optimization is suitably performed by the dose optimization module 26 (as illustrated), an image registration task is suitably performed by an image registration module (not shown), or so forth.

With reference back to FIG. 1, the radiation therapy dose optimization system 16 can also be embodied as a storage medium storing instructions that when executed on the one or more digital processors 20, 22 perform the described radiation therapy dose optimization operations. The storage medium may, for example, include: a hard disk drive or other magnetic storage medium; an optical disk or other optical storage medium; a flash memory, random access memory (RAM), read-only memory (ROM), or other electronic memory medium; various combinations thereof; or so forth.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A system comprising:
a therapy tasks scheduling module configured to construct a workflow schedule for performing a plurality of therapy tasks including dose optimizations; and
a dose optimization module configured to perform a dose optimization in accordance with the workflow schedule to generate a therapy plan corresponding to the dose optimization;
wherein the therapy tasks scheduling module and the dose optimization module comprise one or more digital processors.

2. The system as set forth in claim 1, wherein the therapy tasks scheduling module is configured to (i) assign complexity metrics to the therapy tasks and (ii) construct the workflow schedule based at least on the complexity metrics.

3. The system as set forth in claim 2, wherein the therapy tasks scheduling module is configured to concurrently schedule two or more dose optimizations and to construct the workflow schedule based on an aggregation of the complexity metrics of the concurrently scheduled dose optimizations.

4. The system as set forth in claim 1, wherein the dose optimization module includes plural parallel processing channels, and the therapy tasks scheduling module is configured to concurrently schedule two or more dose optimizations.

5. The system as set forth in claim 1, wherein the therapy tasks scheduling module is configured to construct the workflow schedule such that different user input operations are not scheduled concurrently.

6. The system as set forth in claim 1, wherein the therapy tasks scheduling module is configured to construct the workflow schedule such that operations that do not require user input are performed during off-hour time intervals.

7. The system as set forth in claim 1, wherein the therapy tasks scheduling module is configured to construct the workflow schedule including a scheduled imaging data pre-load operation and one or more scheduled data processing operations timed in the workflow schedule such that imaging data processed by the one or more scheduled data processing operations is preloaded into a memory by the scheduled imaging data pre-load operation.

8. The system as set forth in claim 1, wherein the therapy tasks scheduling module is configured to construct the workflow schedule to (i) group together a plurality of data processing operations operating on a common data set and (ii) keep the common data set in memory during execution of the plurality of data processing operations operating on the common data set.

9. The system as set forth in claim 8, wherein the therapy tasks scheduling module is further configured to schedule a data loading operation that loads the common data set into memory prior to execution of the plurality of data processing operations operating on the common data set.

10. The system as set forth in claim 1, wherein the therapy tasks scheduling module is configured to construct the workflow schedule to reduce variation in computational load over a selected time horizon.

11. The system as set forth in claim 1, wherein the dose optimization module is configured to perform inverse radiation therapy planning that iteratively adjusts a set of radiation therapy parameters to optimize a simulated spatial dose distribution respective to a set of radiation therapy objectives.

12. The system as set forth in claim 11, wherein the dose optimization module is configured to select a region of a fluence map that is smaller than the entire fluence map for updating by an iteration of the iterative inverse radiation therapy planning.

13. The system as set forth in claim 12, wherein the dose optimization module comprises a plurality of processors interconnected as a computing grid, and only the selected region of the fluence map is transferred over the computing grid during the iteration.

14. The system as set forth in claim 11, wherein the simulated spatial dose distribution has a nonuniform voxel size across the volume of the simulated spatial dose distribution.

15. The system as set forth in claim 11, wherein the dose optimization module adjusts voxel sizes of voxels of the simulated spatial dose distribution between iterations of the inverse radiation therapy planning.

16. The system as set forth in claim 11, wherein the dose optimization module performs a first one or more iterations of the inverse radiation therapy planning respective to a first subset of the set of radiation therapy objectives and subsequently performs a second one or more iterations of the inverse radiation therapy planning respective to a second subset of the set of radiation therapy objectives different from the first subset.

17. The system as set forth in claim 11, wherein the dose optimization module performs at least some iterations of the inverse radiation therapy planning respective to a subset of the set of radiation therapy objectives.

18. A storage medium storing instructions that when executed on one or more digital processors perform a method comprising:
performing a dose optimization to generate a therapy plan by inverse radiation therapy planning that iteratively adjusts a set of radiation therapy parameters to optimize a simulated spatial dose distribution respective to a set of radiation therapy objectives, wherein at least some iterations of the inverse radiation therapy planning have a reduced scope comprising at least one of (i) updating a region of a fluence map that is smaller than the entire fluence map and (ii) optimizing the simulated spatial dose distribution respective to a subset of the set of radiation therapy objectives.

19. The storage medium as set forth in claim 18, wherein at least some iterations of the inverse radiation therapy planning update a region of a fluence map that is smaller than the entire fluence map.

20. The storage medium as set forth in claim 18, wherein at least some iterations of the inverse radiation therapy planning optimize the simulated spatial dose distribution respective to a subset of the set of radiation therapy objectives.

21. The storage medium as set forth in claim 20, wherein the method comprises:
performing a first one or more iterations of the inverse radiation therapy planning respective to a first subset of the set of radiation therapy objectives; and
subsequently performing a second one or more iterations of the inverse radiation therapy planning respective to a second subset of the set of radiation therapy objectives different from the first subset.

22. The storage medium as set forth in claim 21, wherein the second subset of the set of radiation therapy objectives includes all radiation therapy objectives contained in the first subset of the set of radiation therapy objectives and further includes at least one additional radiation therapy objective of the set of radiation therapy objectives that is not contained in the first subset of the set of radiation therapy objectives.

23. The storage medium as set forth in claim 20, wherein:
the set of radiation therapy objectives includes N radiation therapy objectives where N is greater than or equal to two;
the radiation therapy objectives of the set of radiation therapy objectives are ranked by priority; and
the subset of the set of radiation therapy objectives includes N_{sub} radiation therapy objectives having highest priority ranking in the set of radiation therapy objectives, where N_{sub} is greater than or equal to one and N_{sub} is less than N.

24. The storage medium as set forth in claim 23, wherein the method comprises:
performing a first one or more iterations of the inverse radiation therapy planning with a first value of N_{sub}; and
subsequently performing a second one or more iterations of the inverse radiation therapy planning with a second value of N_{sub} that is greater than the first value of N_{sub}.

25. A storage medium storing instructions that when executed on one or more digital processors perform a method comprising:
performing a dose optimization to generate a therapy plan by inverse radiation therapy planning that iteratively adjusts a set of radiation therapy parameters to optimize a simulated spatial dose distribution having a nonuniform voxel size respective to a set of radiation therapy objectives.

26. The storage medium as set forth in claim 25, wherein the method further comprises:
adjusting voxel sizes of the voxels of the simulated spatial dose distribution between iterations of the inverse radiation therapy planning.

27. The storage medium as set forth in claim 18, wherein the method further comprises:
on a first one or more processors performing a first dose optimization to generate a first therapy plan by inverse radiation therapy planning; and
concurrently on a second one or more processors performing a second dose optimization to generate a second therapy plan by inverse radiation therapy planning.

28. The storage medium as set forth in claim 18, wherein the iteratively adjusted radiation therapy parameters include one of:
(i) directly controlled radiation therapy parameters, and
(ii) beam fluence maps wherein the method further includes, subsequent to the inverse radiation therapy planning, converting the beam fluence maps to directly controlled radiation therapy parameters to generate the therapy plan.
